(19) United States
(12) Patent Application Publication
(10) Pub. No.: US 2026/0276483 A1
(43) Pub. Date: Sep. 17, 2026

(54) VEHICLE SUPPORT FOR A TEST STAND, AND METHOD FOR SETTING UP A TEST STAND WITH SUCH A VEHICLE SUPPORT

(71) Applicant: AVL List GmbH, Graz (AT)

(72) Inventors: Georg SEEWALD, Graz (AT); Urs GERSPACH, Graz (AT); Jörg FISCHER, Bad Urach (DE); Tobias ZIMMERMANN, Dietramszell (DE); Wolfgang MAUTHNER, Köflach (AT)

(73) Assignee: AVL List GmbH, Graz (AT)

(21) Appl. No.: 19/165,122

(22) PCT Filed: Mar. 13, 2024
(86) PCT No.: PCT/AT2024/060088

§ 371 Date: Sep. 14, 2025

(30) Foreign Application Priority Data
Mar. 14, 2023 (AT) A 50196/2023

(51) Int. Cl. G01M 17/007

(52) U.S. Cl. CPC G01M 17/007

(57) ABSTRACT

Test stands are known in which vehicles have to be brought in on lifting platforms or independently and prepared for connection to the load devices.

In order to shorten the present set-up time and dismantling time on the test stand, a vehicle support (10) is proposed for a test stand (82) which has two longitudinal beams (12, 14), a front crossmember (22) and a rear crossmember (20) by means of which the two longitudinal beams (12, 14) are connected to each other, two bearing portions (26) which extend on the sides of the longitudinal beams (12, 14) facing away from the rear crossmember (20), two bearing portions (26) which extend on the sides of the longitudinal beams (12, 14) facing away from the front crossmember (20) and four supporting elements (36) which are attached to the four bearing portions (26). Rollers (38) are arranged at least on the two supporting elements (36) which are arranged on the sides of the longitudinal beams (12, 14) facing away from the front crossmember (22), and adapter devices (44) to which wheel hubs (46) of a vehicle (48) can be attached are attached to the supporting elements (36). Furthermore, a corresponding method for setting up a test stand with such a vehicle support is proposed.

The invention relates to a vehicle support for a test stand, in particular for a powertrain test stand or a vehicle test stand, as well as a method for setting up a test stand with such a vehicle support.

Powertrain test stands and vehicle test stands usually have a device for generating a load, in particular a drive torque, torsional torque or loading torque, which is then transferred to a hub of a motor vehicle via an adapter device. These adapter devices are usually first attached to the hub of the motor vehicle which, accordingly, must first be correctly positioned in relation to the test apparatus. Since a correct positioning of the hub of the vehicle in relation to the test device in all three spatial axes is necessary here, this often proves difficult, given that the vehicle is no longer drivable after the adapter devices have been fitted.

Vehicle supports have therefore become known with which a vehicle can first be prepared outside of the test stand-in particular, the wheels can for example be removed from the axles- and then brought to the test stand, where the axles of the vehicle can be connected to the corresponding adapter devices of the test stand. In this way, the set-up time and dismantling time at the test stand and thus the time during which this is used for a vehicle is shortened, thus saving costs.

Such a vehicle support is for example known from DE 102011120170A 1 . The vehicle support has a frame on which the vehicle is placed. Rollers or tyres are arranged on the frame so that, even without wheels, the vehicle can be shifted and brought to the test stand, where it can be aligned in the axial direction with the adapter devices of the test stand and connected to these. The adapter devices must be manually arranged in relation to the vehicle axles and fixed to the ground in order to be able to take into account correct wheelbases and track widths of the vehicle.

In addition, a test apparatus with a load device is known from WO 2017/013173 A1 in which an adapter device is attached to the load device and can be moved in the direction of the vehicle axle via a rail. For this purpose, the vehicle is lifted onto a lifting platform at the test stand, where the connection of the adapter device to the wheel hubs of the vehicle can be established. The vehicle can then also be aligned in the height direction in relation to the load device via the lifting platform. However, both the correct alignment of the vehicle in the direction of travel and also the arrangement of the vehicle on the lifting platform are problematic, since in an emergency this cannot be removed from the test stand in a short time. Furthermore, the entire set-up of the vehicle must take place at the test stand, so that long dwell times at the test stand result, without a test run taking place. This reduces the possible utilisation of the test stand and thus increases costs.

The problem which arises is therefore to provide a vehicle support for a test stand as well as a method for setting up a test stand with such a vehicle support, with which the set-up time and the dismantling time at the test stand can be shortened and which makes it possible to simplify the connection of the vehicle under test to the load device. In particular, the effective utilisation times of the test stand should be increased and it should be possible for the vehicle support to be adapted in terms of its dimensions to the dimensions of the vehicle.

This problem is solved by a vehicle support with the features of claim 1.

The vehicle support for a test stand according to the invention has two longitudinal beams which are connected to each other via a front crossmember and a rear crossmember. The crossmembers can either be movable in relation to the longitudinal beams or firmly attached thereto. The rear and front crossmembers extend between the longitudinal beams. On both sides, a bearing portion extends at the level of the two crossmembers, on the other side of the longitudinal beams, which can be connected either to the longitudinal beam or to the crossmember. The two longitudinal beams are, accordingly, arranged between the bearing portions. A supporting element is attached to each of the bearing portions. This attachment can be indirect or direct and can also allow a guided movement between the supporting element and the bearing portions. Rollers are arranged at least on the two supporting elements which are arranged on the sides of the longitudinal beams facing away from the front crossmember which allow the vehicle support to be moved and which, accordingly, rest on the ground. Furthermore, adapter devices are attached to the supporting elements to which wheel hubs of a vehicle can be attached. These adapter devices have a rotatable mounting which can be connected to a load device, for example. Thanks to the adapter devices attached directly to the supporting elements, the vehicle can be prepared at a distance from the test stand, for example at a set-up station. The vehicle can then be lifted by means of a lifting platform and aligned vertically with respect to the adapter devices, whereupon the wheels can be removed and the wheel axles can be connected to the adapter devices at the set-up station. The vehicle prepared in this way can then be lowered and moved, together with the movable vehicle support, by means of the rollers and positioned at the test stand. This reduces the set-up time to establishing the connection to the load device at the test stand, since only the connection of the adapter devices to the load device at the test stand needs to be carried out. The utilisation time of the test stand is also improved. Furthermore, in an emergency, the vehicle can be removed from the test stand in a very short time with the vehicle support, for which purpose only the connection between the load device and the adapter devices needs to be disconnected.

Preferably, the supporting elements with the adapter devices can be swivelled with respect to the longitudinal beams. This swivel movement allows a distance between the adapter devices to be adjusted according to the track width of the vehicle.

In a design representing a further development of this aspect, the supporting elements with the adapter devices can be swivelled with respect to the longitudinal beams in a horizontal plane in such a way that an axis of rotation of a rotatable mounting of the adapter devices which can be connected to the wheel hub of the vehicle and, on the opposite side, to a drive axle of the load device, is, in each swivel position, arranged perpendicular to a vertical plane through the adjacent longitudinal beams. In this context, the horizontal plane is understood to be a plane that is arranged parallel to the surface on which the vehicle support stands, while the vertical plane is arranged through the longitudinal beams, perpendicular to this horizontal plane, and runs along the direction of extension of the longitudinal beams. It follows that, for all track widths to be adjusted, there is always a correct alignment of the axis of rotation of the adapter devices to the vehicle axle. In this way, tensions in the chassis caused by the attachment are avoided. Accordingly, there is no need for an additional alignment of the adapter devices with regard to the angle in relation to the longitudinal beams.

It is particularly preferable if the swivelling is carried out by means of a parallel arm system, via which the bearing portions are connected to the supporting elements. This parallel arm system allows adjustment to the track width of the vehicle, whereby this adjustment is effected through the swivel movement before the vehicle is attached. In this way, a certain degree of freedom is maintained between the longitudinal beams and the supporting elements, which prevents the vehicle axles from being twisted against each other, in particular while the vehicle support is being moved, and nonetheless achieves a sufficient attachment of the vehicle so that the vehicle can also remain on the vehicle support during the test run.

In a further development of this aspect of the invention, each parallel arm system consists of two equally long push rods aligned parallel to each other, wherein a bearing eye is in each case formed at the opposite ends of the push rods, with which the push rod is mounted at one end on the supporting element and mounted on the bearing portion at its opposite end, wherein the distances and angular offset of the bearing eyes with respect to the longitudinal beams on the supporting element correspond to the angular offset and the distances of the bearing eyes with respect to the longitudinal beams on the bearing portion. In this way, the correct alignment of the axis of rotation of the adapter devices to the vehicle axle is ensured in a simple way.

Furthermore, it is advantageous if the adapter devices on the supporting elements can be aligned with the vehicle axle by means of levelling screws. Manufacturing tolerances or deformations that may occur over time can be compensated for by means of the levelling screws at the set-up station or finally at the test stand to ensure horizontal alignment of the axes of rotation of the adapter devices and free movement of the vehicle at the test stand. By correctly adjusting the levelling screws, warping of the vehicle axles or the chassis in relation to the adapter devices can be reliably prevented. Such adjustment can also be carried out after the wheel hubs have been attached to the adapter devices, in order to prevent damage to the vehicle.

Furthermore, the adapter devices are advantageously arranged on the supporting elements so as to be movable to a limited extent and can be locked by means of a fixing device, so that the adapter devices are prevented from slipping with the vehicle on the supporting elements during the movement of the vehicle support. Due to the limited movability of the adapter devices on the supporting elements, manufacturing tolerances can be compensated for and tensions on the vehicle can be avoided during the test run.

The limitation of the movability is preferably effected by stop elements on the supporting element, at least some of which have a damping element. In this way, shocks to the chassis during the tests can be prevented, as these are cushioned by the damping element.

In a preferred design, the adapter devices are locked on the supporting elements by means of clamps. This can be achieved by means of simple locking levers, so that slipping of the vehicle during transport can be prevented with minimal effort.

In addition, the adapter devices preferably each have a lower bearing plate to which ball casters are attached with which the bearing plate rests on the respective supporting element. Thus, slight movements of the adapter device on the support plate in two axis directions are possible during the test process. This also makes it easier to connect the adapter device to the load device, as minor corrections of the axes relative to each other can be easily made.

Furthermore, it is advantageous if the supporting elements are interchangeable. This makes it possible to adjust the height of the wheel mount to the axle height of the vehicle in that the supporting elements have different heights.

In order also to be able to make a correct adjustment of the adapter devices on the vehicle support to the wheelbase of the vehicle, the distance of the front crossmember with the supporting elements to the rear crossmember with the supporting elements can be changed.

This adjustment of the wheelbase is particularly easy to carry out if the two longitudinal beams can be moved telescopically into and apart between the two crossmembers. For this purpose, the two longitudinal beams can each have an outer hollow rail and an inner rail which can be moved within the outer hollow rail. In this case, there is therefore a positive fit on four sides, which only leaves free the degree of freedom of retraction and extension in the horizontal direction. As soon as the rail has extended or retracted so far within the hollow rail that there is a correct alignment of the supporting elements to the vehicle axles, the vehicle can be lowered accordingly and attached to the supporting elements or placed thereon. In such a design, one of the crossmembers is for example attached to the two outer hollow rails of the longitudinal beams, while the second crossmember is attached to the two inner rails or can be moved on these. Thus, the distance of the supporting elements in the direction of extension of the vehicle can be adjusted correctly to the wheelbase of the vehicle in a simple way.

Preferably, rollers are also formed on the supporting elements of the rear crossmember. These serve to partially absorb forces when moving the vehicle support and enable the vehicle support to be shifted on the ground and thus enable the vehicle, with the vehicle support, to be aligned with respect to the lifting platform or the load device.

The rollers are preferably arranged at the end of the supporting elements distant from the parallel arm system, as a result of which the rollers remain accessible even after the vehicle has been set down.

In a preferred embodiment, at least one of the crossmembers can be moved on the longitudinal beams and fixed in its end position. This provides an additional option for adjusting the supporting elements according to the vehicle's wheelbase.

An additional possibility for adjusting the distance between the supporting elements in the direction of extension of the longitudinal beams, and thus adjusting to the wheelbase of the vehicle, is achieved in that the front crossmember can be slid onto the longitudinal beams in two positions rotated by 180° around a vertical axis, so that the supporting elements point away from the rear crossmember in the first position and point towards the rear crossmember in the second position. Such an adjustment allows the wheelbase to be set to particularly small distances.

In a preferred embodiment, a fork pocket is formed between the two longitudinal beams on the side of the rear crossmember opposite to the front crossmember. The fork pocket allows a forklift vehicle, such as a lift truck, to be driven in under the vehicle support so that this can be moved by means of the forklift vehicle. During this movement, the vehicle support is supported on the ground by the wheels of the forklift vehicle and the rollers on the front crossmember. In order to be able to lift the vehicle support slightly on the rear side so that it can be moved using the forklift vehicle and thus make it movable using the forklift vehicle, the fork pocket can be attached between the longitudinal beams via an axis of rotation. In this way, the vehicle support is lifted via the axis of rotation, while the fork pocket can remain horizontal due to the rotation around the axis of rotation that is then required. For this purpose, the axis of rotation can advantageously be arranged in a region of the fork pocket distant from the rear crossmember, as a result of which the main force absorption point is arranged as close as possible to the centre of gravity of the forklift vehicle. Furthermore, a stop for the fork pocket may be formed on the rear crossmember or on an inner side of the longitudinal beams which restricts the rotation of the fork pocket around the axis of rotation. This prevents the vehicle support from being lifted so far, and thus the fork pocket from being rotated so far, at its region distant from the axis of rotation, in the direction of the vehicle underbody that the fork pocket touches the underside of the vehicle, which could cause damage to this.

The object is also achieved by a method for setting up a test stand with such a vehicle support; first, a vehicle is lifted by means of a permanently installed lifting platform, and then the vehicle support is placed beneath the vehicle. The vehicle support is then adjusted so as to correspond to the track width and the wheelbase of the vehicle, with respect to the track width of the vehicle by rotating the supporting elements by means of the parallel arm system and with respect to the wheelbase of the vehicle by changing the distance between the front crossmember with the supporting elements and the rear crossmember with the supporting elements. This can be done by retracting or extending the telescopic rails or by moving or rotating the front crossmember on the longitudinal beam. Then, or beforehand, the vehicle is lowered to the appropriate height in relation to the adapter devices by means of the lifting platform and the adapter devices are mounted on the wheel hubs of the vehicle, so that the vehicle is now completely supported by the vehicle support and the vehicle can be fully lowered by means of the lifting platform. The vehicle support, with the vehicle, can now be driven to the test stand using a forklift vehicle, for example by driving the forks of the forklift vehicle under the fork pocket and lifting the vehicle support slightly in the rear region. At the test stand, the vehicle is aligned with the load device and the adapter devices are connected to the load device for testing. After the tests have been carried out, the vehicle can be driven back from the test stand to the set-up station, where it can be again driven to the lifting platform and disconnected from the adapter devices and thus from the vehicle support. This method significantly reduces cycle times at the test stand, since almost the entire set-up time no longer takes place at the test stand, but at the separate set-up station.

Thus, a vehicle support for a test stand and a method for setting up a test stand with such a vehicle support is provided with which the set-up times at the test stand can be significantly shortened, since it enables the vehicle, fully set-up beforehand, to be moved easily. An adaptation of the vehicle support to the respective vehicle under test, both in terms of the wheelbase and the track width, can be carried out very easily and quickly. In addition, for the first time, the testing of a vehicle can be carried out directly on a vehicle support, with which the vehicle can also be removed from the test stand very quickly in an emergency. Accordingly, it is no longer necessary to remove the vehicle from the vehicle support.

A non-limiting exemplary embodiment of a vehicle support for a test stand according to the invention as well as the method for setting up a test stand with such a vehicle support is described in the following with reference to the figures.

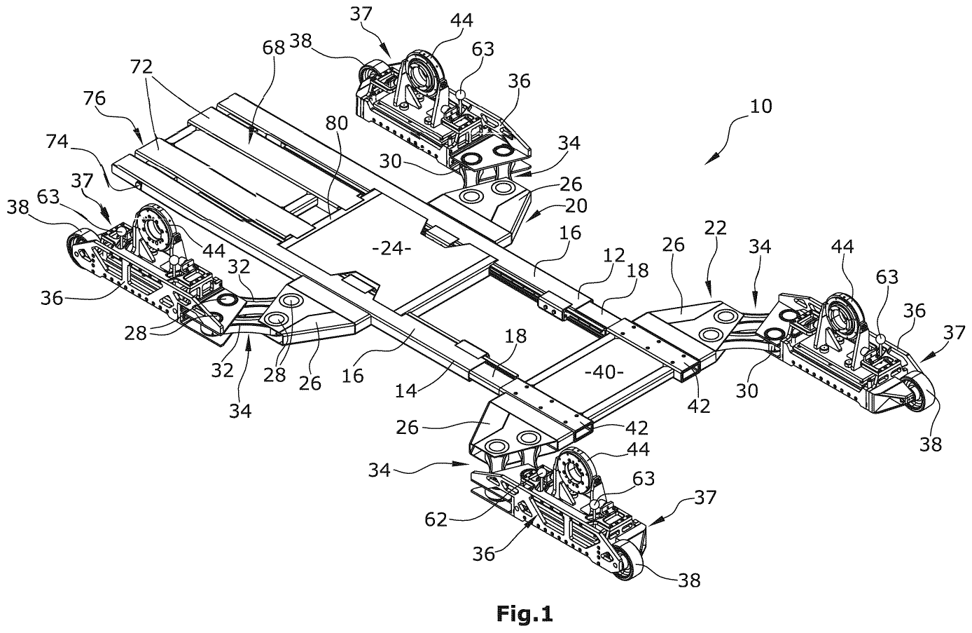

FIG. 1 shows a vehicle support according to the invention in a perspective view.

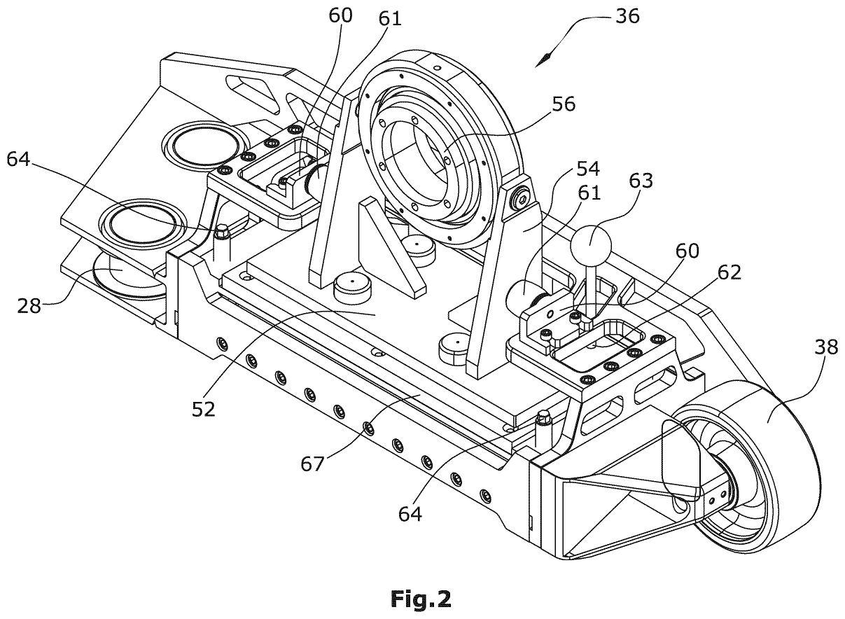

FIG. 2 shows a supporting element of the vehicle according to the invention from FIG. 1 in a perspective view.

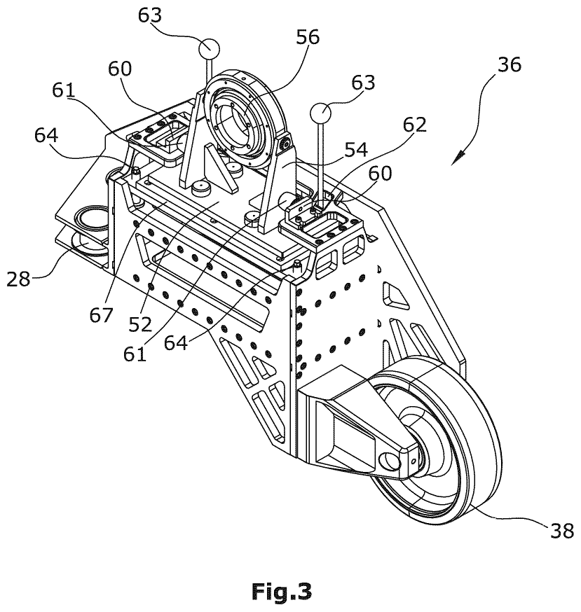

FIG. 3 shows an alternative supporting element of the vehicle according to the invention from FIG. 1 in a perspective view.

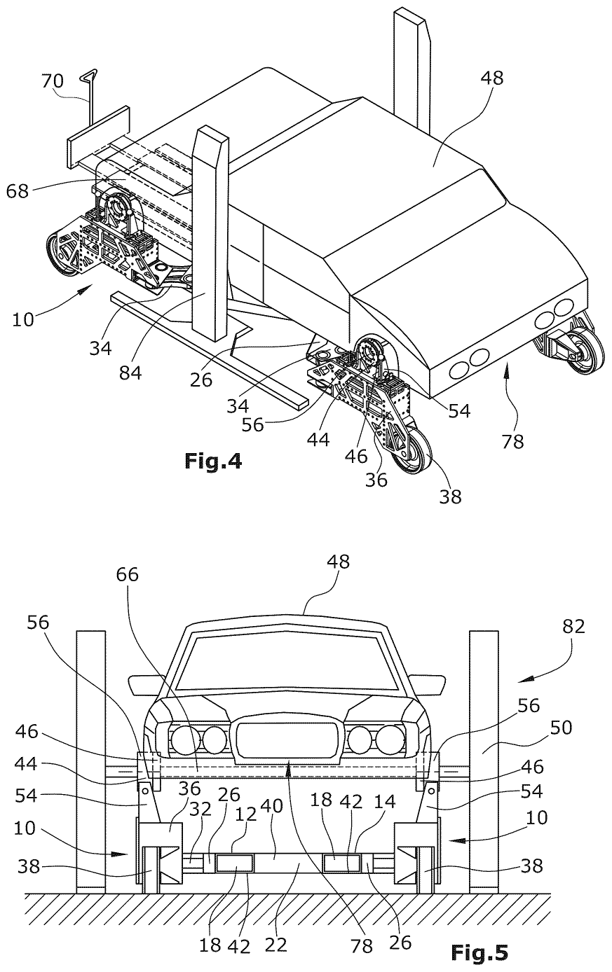

FIG. 4 shows the vehicle support on the lifting platform at the set-up station with the vehicle and a forklift vehicle.

FIG. 5 shows a front view of the vehicle support with a vehicle at a test stand.

The vehicle support 10 shown in FIG. 1 has a first longitudinal beam 12 and a second longitudinal beam 14 which are aligned parallel to each other and each have an outer hollow rail 16 in a rear region and an inner rail 18 that can be moved within the outer hollow rail 16 in the front region, as a result of which the length of the longitudinal beams 12, 14 is variably adjustable. The terms “rear” or “front” refer to a usual direction of movement of the vehicle support 10 and serve to facilitate understanding, without being limiting in effect.

The two longitudinal beams 12, 14 are connected to each other in the region of the outer hollow rail 16 by a rear crossmember 20 and in the region of the inner rail 18 by a front crossmember 22.

The rear crossmember 20 consists of three parts that are attached to the outer hollow rail of the longitudinal beams 12, 14. A middle crossmember section 24 is arranged between the two longitudinal beams 12, 14 and attached thereto, while bearing portions 26 extend from the outer sides of the two longitudinal beams 12, 14 perpendicular to the longitudinal beams 12, 14. These have two bearing pins 28 on their side facing away from the front crossmember 22 for mounting a bearing eye 30 of a push rod 32. The two push rods 32 are arranged in such a way as to form a parallel arm system 34, whereby the push rods 32 also have a bearing eye 30 at their opposite ends into which a bearing pin 28 protrudes which is fixed in a corresponding opening at a front end of a supporting element 36 opposite the rear end of the bearing portion 26. The distances and the angular offset of the bearing pins 28 with respect to the longitudinal beams 12, 14 on the supporting element 36 correspond to the angular offset and the distances of the bearing pins 28 with respect to the longitudinal beams 12, 14 on the bearing portion 26. Also, the two push rods 32 are of the same length, so that the parallel arm system 34 is formed, as a result of which the supporting element 36 can be rotated around the bearing portion 26, whereas its angular position is retained when rotating with respect to the longitudinal beams 12, 14.

In each case at an end 37 facing away from the parallel arm system 34, a roller 38 is attached to the supporting elements 36 of the rear crossmember 20 with which the rear crossmember 20 rests on the ground on both sides. Accordingly, the rollers 38 face a rear end of the supporting elements 36 and the vehicle support 10.

The front crossmember 22 consists of a total of five parts which are attached to each other. A middle crossmember section 40 is arranged between the two longitudinal beams 12, 14 and attached on both sides to a square tube 42 which has been pushed onto the inner rails 18 of the two longitudinal beams 12, 14 and is correspondingly supported on the inner rail 18, for which purpose the inner cross-section of the square tubes 42 is designed to correspond to the outer cross-section of the inner rails 18. On the front crossmember 22 too, these square tubes 42 are in each case connected on the outward-facing side to a bearing portion 26 which substantially corresponds to the bearing portions 26 of the rear crossmember 20, but points in the opposite direction, so that the supporting elements 36 of the front crossmember 22, which are attached to the bearing portions 26 via the known parallel arm system 34, also point in the other direction, i.e. forward. The bearing portions 26 of the front crossmember 22 also extend perpendicular to the longitudinal beams 12, 14 and are connected to the bearing portions via the two parallel push rods 32. Rollers 38 are also attached at the forward-facing ends of the supporting elements 36 of the front crossmember 22 which rest on the ground, so that the vehicle support 12 can be moved by means of the four rollers 38 of the rear and front supporting elements 36.

An adapter device 44 is arranged on each of the supporting elements 3. This is connected to a wheel hub 46 of a vehicle 48 and serves as an intermediate piece between [the wheel hub and] a load device 50 for introducing a torque to the vehicle axles 66 via the wheel hubs 46.

As can be seen in FIGS. 2 and 3, this adapter device 44 has a lower bearing plate 52 supporting a bearing block 54 on which a rotatable mounting 56 is mounted which can be connected to the wheel hub 46 of the vehicle 48 and, on the opposite side, to a drive axle 58 of the load device 50, as shown schematically in FIG. 5.

On the lower side of the bearing plate 52, with which the adapter device 44 is placed on the supporting element 36, several ball casters, not visible in the figures, are formed which make it possible to shift the adapter device 44 slightly on the supporting elements 36. In this way, internal tensions on the chassis can be prevented by attaching the vehicle 48 to the adapter devices 44 and thus to the vehicle support 10, since the adapter devices 44 can adjust their alignment, at least slightly. This can also prevent tensions during the tests.

The freedom of movement is limited by stop elements 60 which are formed on the supporting elements 36. The stop elements 60 surround the bearing plate 52 on three sides and extend from the region in front of the bearing plate 52 over the lateral region facing away from the longitudinal beam 12, 14 to the region behind the bearing plate 52. In addition, the stop elements 60 also extend over the bearing plate 52 in the direction of the bearing block 54. A damping element is in each case arranged at the ends facing the bearing blocks 54 against which the adapter device 44 strikes if displaced too far. This stop is damped accordingly so that vibrations are avoided. The region of the stop elements 60 extending around the adapter device 44 prevents an excessive outward displacement of the adapter devices, while the damping elements 61 limit an axial displacement on the supporting elements 36. Due to the distance from the stop elements 61, a slight rotation on the supporting elements 36 is also possible.

In addition, fixing devices 62 are formed in the region of the stop elements 60 which can be operated by means of locking levers 63 and by means of which a fixation of the bearing plate 52 and thus the adapter device 44 can be created in order to prevent the adapter devices 44 from detaching from the vehicle support 10 while being moved with the vehicle 48.

Furthermore, four levelling screws 64 are arranged on each supporting element 36 which can be used to align the axes of rotation of the adapter devices 44 exactly with the vehicle axles 66 in order to avoid tensions in the chassis. Using these levelling screws 64, a support plate 67 of the supporting element 36 below the adapter device 44 is lifted or lowered accordingly at its corners and aligned in this way, which can also compensate for any wear or manufacturing and assembly tolerances that may occur.

A fork pocket 68 for a forklift vehicle 70 is arranged at the rear end of the longitudinal beams 12, 14 and thus on the side of the rear crossmember 22 opposite to the front crossmember 22. This has two lifting rails 72 under which the fork of the forklift vehicle 70 can be driven in. The entire fork pocket 68 is connected to the longitudinal beams 12, 14 via an axis of rotation 74. This axis of rotation 74 is located in the region 76 of the fork pocket 68 distant from the rear crossmember 20, so that the fork pocket 68 is rotatable relative to the longitudinal beams 12, 14 around this axis of rotation 74. Accordingly, if the forks of a forklift vehicle 70 are pushed under the fork pocket 68, and then the forks are lifted, the longitudinal beams 12, 14 are lifted in the rear region via the axis of rotation 74. In this case, the fork pocket 68 roughly maintains its horizontal position, while the longitudinal beams 12, 14 are rotated slightly. In order to prevent a rotation of the fork pocket 68 from below against a vehicle underbody 78 during this movement, this relative rotation is limited by a stop 80 for the fork pocket 68, which in the present exemplary embodiment is formed on the rear side of the rear crossmember 20. Accordingly, the lifting of the vehicle support 10 with the vehicle 48 arranged thereon is limited.

The set-up of the vehicle 48 for a test stand 82 is carried out outside of the test stand 82, as shown in FIG. 4, in that the vehicle 48 is first driven to a known, permanently installed lifting platform 84 at a preliminary set-up station and lifted by the lifting platform 84. The vehicle wheels can then be dismantled and the vehicle lowered so far that the vehicle axles 66 are at the same height as the axes of rotation of the adapter devices 44. By retracting and extending the telescopic longitudinal beams 12, 14 and simultaneously swivelling the supporting elements 36 and thus the adapter devices 44 around the parallel arm system 34, the vehicle support 10 is then aligned with the vehicle 48 with respect to its track width and wheelbase in such a way that the axes of rotation of the adapter devices 44 are arranged on the vehicle axles 66 and the adapter devices 44 are positioned directly opposite to the wheel hubs 46. The parallel arm system 34 ensures that, in each swivel position of the supporting element 36, the axis of rotation of the adapter devices 44 is aligned perpendicular to a plane which is spanned by a vertical section, along the direction of extension of a longitudinal beam 12, 14, through the longitudinal beam 12, 14, as a result of which the axis of rotation of the adapter devices 44 is always arranged parallel to the vehicle axle 66 if the vehicle 48 is arranged correctly in relation to the vehicle support 10.

The exact alignment of the axes of rotation of the adapter devices 44 to the vehicle axles 66 is carried out by means of the levelling screws 64. The adapter devices 44 are then connected to the wheel hubs 46, as a result of which the vehicle 48 is completely supported by the vehicle support 10 and the lifting platform 84 can be lowered accordingly.

The forklift vehicle 70 can then be driven with its forks under the fork socket 68 and the forks can be raised slightly after the adapter devices 44 have been fully attached to the vehicle support 10 by means of the fixing devices 62. The vehicle support 10 is now moved into the test stand 82, which is shown in FIG. 5, by means of the forklift vehicle 70 and aligned with a drive axle 58 of a load device 50 by means of the vehicle support 10. The adapter device 44 is then connected to the load device 50. The fixing devices 62 are released again so that a certain movability of the adapter devices 44 is maintained. The chassis tests can then be carried out while the vehicle 48 remains on the vehicle support 10. After the end of the test, or in an emergency, the vehicle 48 is disconnected from the load device 50 again and removed from the test stand 82 by means of the vehicle support 10 and the forklift vehicle 70. Dismantling takes place in substantially the same way as when setting up the vehicle 48, only in reverse order.

With this vehicle support 10, vehicles 48 with particularly high hub heights can also be tested without any problems, since the supporting elements 36 can be easily detached from the rest of the vehicle support 10 using the parallel arm system 34 and can then be replaced by supporting elements 36 with a higher hub height, as shown in FIG. 3.

Accordingly, such a vehicle support makes it possible for the entire preliminary set-up of the vehicle, with the exception of the connection to the load device, to be carried out outside of the test stand and for the vehicle then to be shifted into the test stand by means of the vehicle support. This results in better utilisation of the test stands, since set-up and dismantling times at the test stand are reduced to a minimum. Adjustment to any given wheelbases and track widths is also possible.

It should be clear that the invention is not limited to the exemplary embodiment described above; rather, a large number of design modifications of the movable vehicle support are possible. For example, instead of the fork pocket, a different force application device can be provided if a different transfer vehicle is to be used. The crossmembers can also be manufactured as a single piece or can be divided differently.

1. Vehicle support (10) for a test stand (82) with two longitudinal beams (12, 14),
a front crossmember (22) and a rear crossmember (20) by means of which the two longitudinal beams (12, 14) are connected to each other, two bearing portions (26) which extend on the sides of the longitudinal beams (12, 14) facing away from the rear crossmember (20),
two bearing portions (26) which extend on the sides of the longitudinal beams (12, 14) facing away from the front crossmember (20),
four supporting elements (36) which are attached to the four bearing portions (26), wherein rollers (38) are arranged at least on the two supporting elements (36) which are arranged on the sides of the longitudinal beams (12, 14) facing away from the front crossmember (22), wherein adapter devices (44) are attached to the supporting elements (36), on which wheel hubs (46) of a vehicle (48) can be attached.

2. Vehicle support (10) for a test stand (82) according to claim 1,
wherein
the supporting elements (36) with the adapter devices (44) can be swivelled with respect to the longitudinal beams (12, 14).

3. Vehicle support (10) for a test stand (82) according to claim 1,
wherein
the supporting elements (36) with the adapter devices (44) can be swivelled with respect to the longitudinal beams (12, 14) in a horizontal plane in such a way that an axis of rotation of a rotatable mounting (56) of the adapter devices (44) which can be connected to the wheel hub (46) of the vehicle (48) and, on the opposite side, to a drive axle (58) of the load device (50) is, in each swivel position, arranged perpendicular to a vertical plane through the adjacent longitudinal beams (12, 14).

4. Vehicle support (10) for a test stand (82) according to claim 3,
wherein
the swivelling is carried out by means of a parallel arm system (34), via which the bearing portions (26) are connected to the supporting elements (36).

5. Vehicle support (10) for a test stand (82) according to claim 4,
wherein
each parallel arm system (34) consists of two equally long push rods (32) aligned parallel to each other, wherein a bearing eye (30) is in each case formed at the opposite ends of the push rods (32) with which the push rod (32) is mounted at one end on the supporting element (36) and mounted on the bearing portion (26) at its opposite end, wherein the distances and angular offset of the bearing eyes (30) with respect to the longitudinal beams (12, 14) on the supporting element (36) correspond to the angular offset and the distances of the bearing eyes (30) with respect to the longitudinal beams (12, 14) on the bearing portion (26).

6. Vehicle support (10) for a test stand (82) according to claim 1,
wherein the adapter devices (44) on the supporting elements (36) can be aligned with the vehicle axle (66) by means of levelling screws (64).

7. Vehicle support (10) for a test stand (82) according to claim 1,
wherein
the adapter devices (44) are arranged on the supporting elements (36) to be moved to a limited extent and can be locked by means of a fixing device.

8. Vehicle support (10) for a test stand (82) according to claim 7,
wherein
the limitation of movability is effected by stop elements (60) on the supporting element (36), at least some of which have a damping element.

9. Vehicle support (10) for a test stand (82) according to claim 7,
wherein
the adapter devices (44) are locked on the supporting elements (36) by means of clamps.

10. Vehicle support (10) for a test stand (82) according to claim 1,
wherein
the adapter devices (44) each have a lower bearing plate (52) to which ball casters are attached with which the bearing plate (52) rests on the respective supporting element (36).

11. Vehicle support (10) for a test stand (82) according to claim 1,
wherein
the supporting elements (36) are interchangeable.

12. Vehicle support (10) for a test stand (82) according to claim 1,
wherein
the distance of the front crossmember (22) with the supporting elements (36) from the rear crossmember (20) with the supporting elements (36) can be changed.

13. Vehicle support (10) for a test stand (82) according to claim 1,
wherein
the two longitudinal beams (12, 14) can be moved telescopically into and apart from each other between the two crossmembers (20, 22).

14. Vehicle support (10) for a test stand (82) according to claim 1,
wherein
rollers (38) are formed on the supporting elements (36) of the rear crossmember (20).

15. Vehicle support (10) for a test stand (82) according to claim 4,
wherein
the rollers (38) are arranged at the end (37) of the supporting elements (36) distant from the parallel arm system (34).

16. Vehicle support (10) for a test stand (82) according to claim 1,
wherein
at least one of the crossmembers (20, 22) can be moved on the longitudinal beams (12, 14) and can be fixed in its end position.

17. Vehicle support (10) for a test stand (82) according to claim 16,
wherein
the front crossmember (22) can be slid onto the longitudinal beams (12, 14) in two positions rotated by 180° around a vertical axis, so that the supporting elements (36) point away from the rear crossmember (20) in the first position and point towards the rear crossmember (20) in the second position.

18. Vehicle support (10) for a test stand (82) according to claim 1,
wherein
a fork pocket (68) is formed between the two longitudinal beams (12, 14) on the side of the rear crossmember (20) opposite to the front crossmember (22) which is attached to the two longitudinal beams (12, 14) via an axis of rotation which is arranged in a region (76) of the fork pocket (68) distant from the rear crossmember (20).

19. Method for setting up a test stand (82) with a vehicle support (10) according to claim 1,
in which
a vehicle (48) is lifted by means of a permanently installed lifting platform (84),
the vehicle support (10) is placed beneath the vehicle (48),
the vehicle support (10) is adjusted with respect to its track width by rotating the supporting elements (36) by means of the parallel arm system (34) and is adjusted with respect to its wheelbase by changing the distance between the front crossmember (22) with the supporting elements (36) and the rear crossmember (20) with the supporting elements (36),
the adapter devices (44) are mounted on the wheel hubs (46) of the vehicle (48),
the vehicle (48) is completely lowered by means of the lifting platform (84),
the vehicle support (10) with the vehicle (48) is driven to the test stand (82) by means of a forklift vehicle (70),
the adapter devices (44) are connected to a load device (50) for testing on the test stand (82).
